(19) United States
(12) Patent Application Publication
(10) Pub. No.: US 2016/0039326 A1
(43) Pub. Date: Feb. 11, 2016

(54) Mobile Cooking Cart

(71) Applicants: Jonathan Smith, San Antonio, TX (US); Steven Ronald Raike, San Antonio, TX (US)

(72) Inventors: Jonathan Smith, San Antonio, TX (US); Steven Ronald Raike, San Antonio, TX (US)

(21) Appl. No.: 14/298,937

(22) Filed: Aug. 8, 2014

(51) Int. Cl. B60P 3/025; F24C 15/18

(52) U.S. Cl. CPC B60P 3/0257; F24C 15/18

(57) ABSTRACT

The present invention is an indoor portable or demonstration cooking cart. Specifically it allows a cooktop and ventilation system to be integrated into the structure of a movable cooking cart and allow its use at any location with a compatible floor connection.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF THE INVENTION

This invention relates generally to an indoor or outdoor portable or demonstration cooking cart. Specifically it allows a cooktop and ventilation system to be integrated into the structure of a mobile cooking cart and allow its use at any location with a compatible floor connection.

Traditionally mobile and demonstration cooking carts particularly indoor ones do not utilize cooktops as part of their assembly due to problems venting. This problem has been partially solved by others by either simply not having the cooktop be a part of the mobile cart assembly altogether by locating the cooktop in an adjacent built in area, or by employing a large permanent bulky ventilation hood system overhead.

The cooktop in an adjacent area approach takes the focus away from the user (cook or chef) who is engaged cooking at the cart. The user is usually facing an audience and they are forced to move away from the focal point to reach the cooktop. It also means the installation of a permanent cooktop where it may only be used intermittently.

The overhead vent hood approach also has disadvantages. Placing a large overhead vent hood is visually distracting and in addition is not suitable to spaces with high ceilings.

### SUMMARY OF THE INVENTION

It is therefore an object of the instant invention to provide an improved integrated cooking system for a mobile cooking cart.

It is a further object of the instant invention to provide a cooktop system on the mobile cooking cart countertop.

It is another object of the instant invention to provide a ventilation system integrated into the mobile cooking cart.

It is a further object of the instant invention to provide a usable flexible space when the cart has been moved away and not in use.

It is yet another object of the instant invention to provide a physical connection from the cart through the adjacent floor for venting.

Briefly, the instant invention achieves these objects in a portable kitchen cart. The invention contains a cooktop and ventilation system. When needed the invention is moved into a predetermined location where under floor venting ducts are located. The invention is placed over and connected to a venting duct in the floor (covered by a flat panel when not in use). This allows the space to be completely free of cooking and venting equipment when not in use. When in use the user can engage with the audience while utilizing the cooktop. It can also allow the invention to be used multiple places; all that is needed is the requisite floor hookup.

Details of the mobile cooking cart and further objects and advantages thereof will become evident as the description proceeds and from an examination of the accompanying sheets of drawings.

### BRIEF DESCRIPTION OF THE DRAWINGS

FIG. 1 is an isometric view illustrating the general layout of the of the present invention

FIG. 2 is a hidden line isometric view illustrating the connection to the floor of the present invention

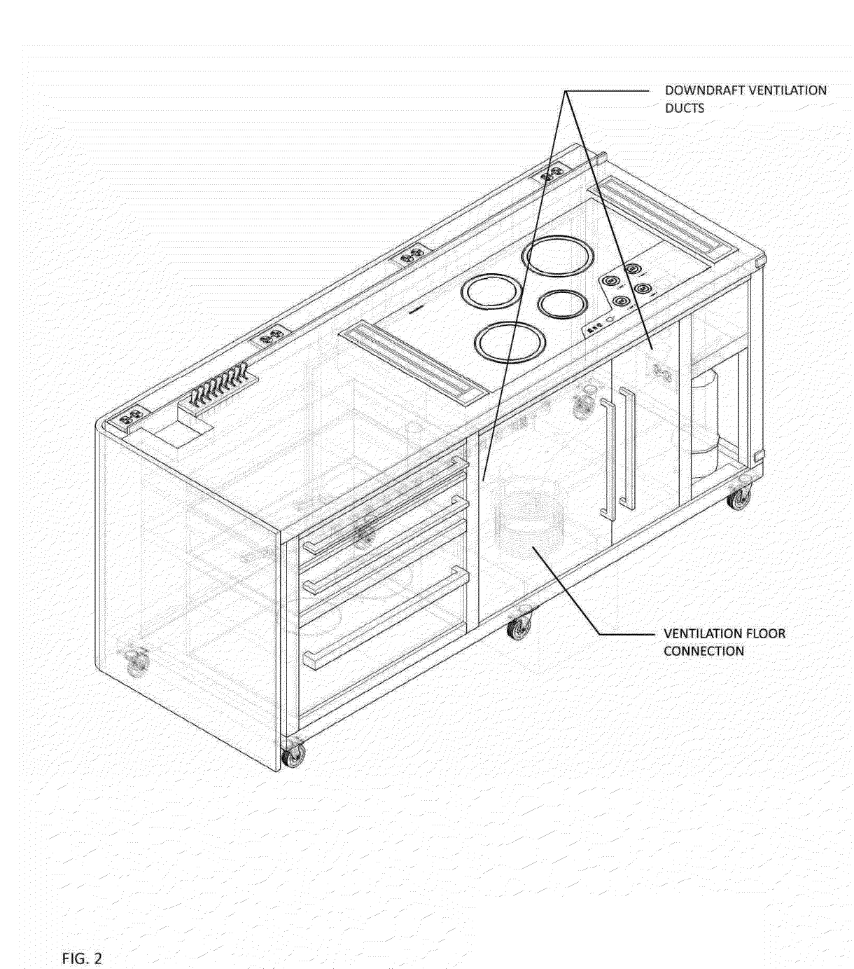

FIG. 3 is an elevation illustration the flow of downdraft air through of the present invention

FIG. 4 is a sequential set of isometric drawings showing set up and take down of the present invention

FIG. 5 is a perspective illustrating the view of the cart from the audience's perspective showing the lack of obtrusive overhead ventilation hood to the present invention

### DETAILED DESCRIPTION OF THE INVENTION

The present invention is an indoor portable or demonstration cooking cart. Specifically it allows a cooktop and ventilation system to be integrated into the structure of a movable cooking cart and allow its use at any location with a compatible floor connection.

Accordingly the reader will see that the mobile cooking cart can be easily moved and utilized for cooking while maintaining a flexible space, free of built-in cooktops or bulky vent hoods when not in use. The cart enables any space with a compatible floor box to become a temporary kitchen. Furthermore the mobile cooking cart has the additional advantages in that.

it permits the user (cook) to interact with the audience while utilizing the cooktop;

it permits the cart to be both mobile and contain a cooktop;

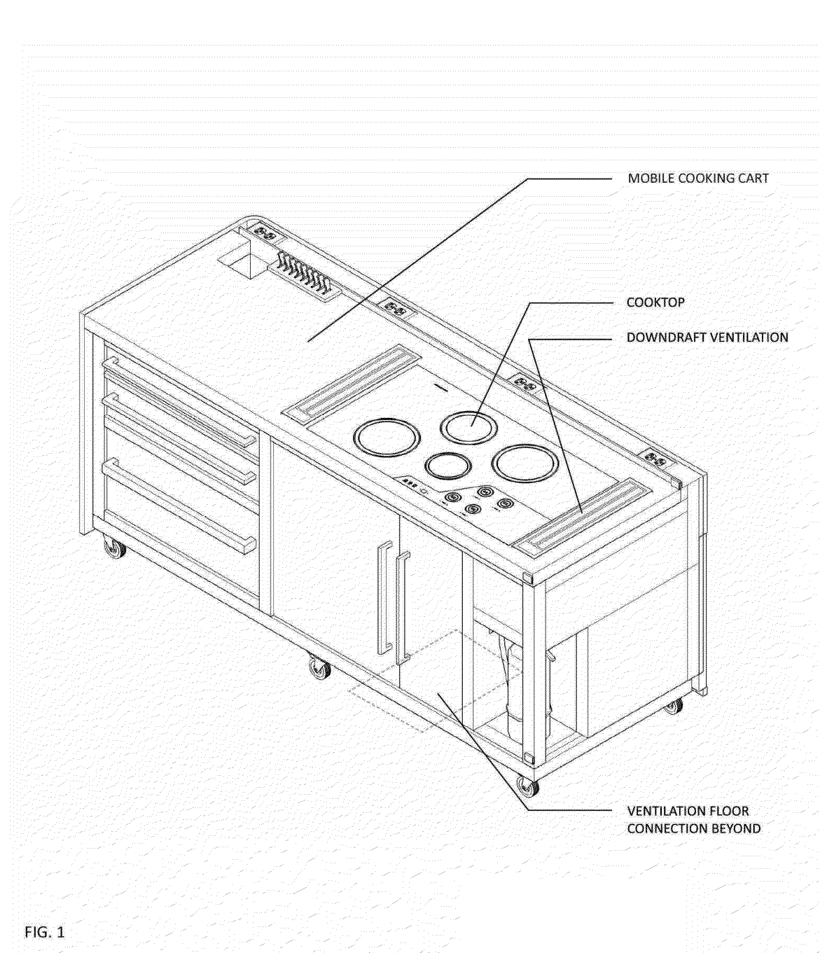

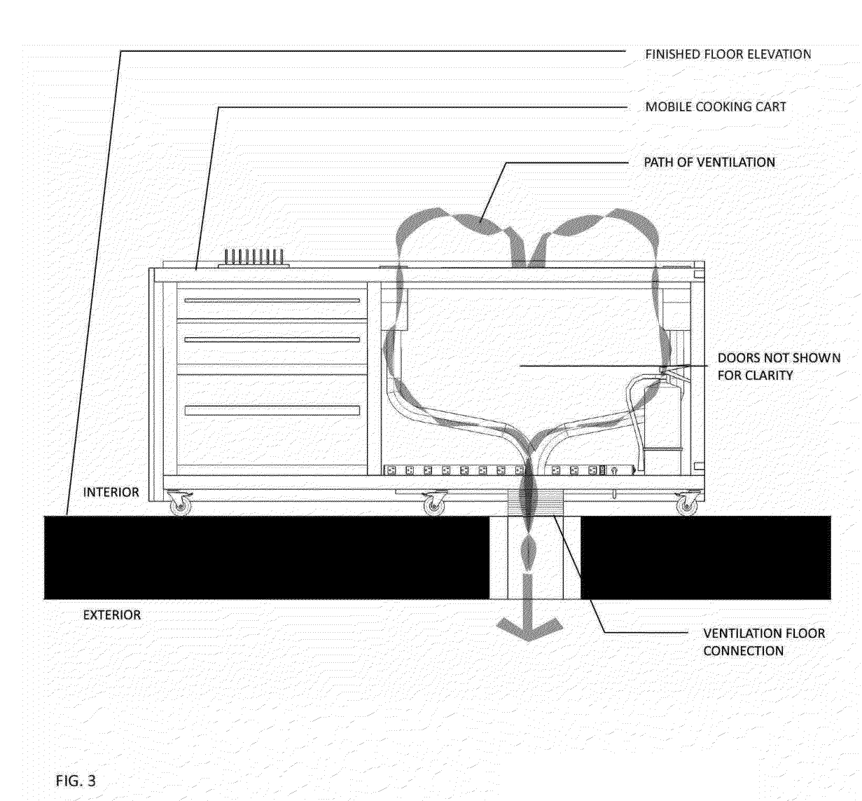

Referring now to the invention in more detail, in FIG. 1 there is shown the mobile cooking cart with integrated cooktop as well as a ventilation system. FIG. 1 also shows the location for the ventilation component connection to the floor which is shown in more detail in FIG. 3.

FIG. 3 illustrates how the cart connects with the floor box to ventilate the fumes from cart and move the air out of the immediate area. The air passes through the ventilation system on the cart through the duct connection and through the floor box; from there is taken directly to the exterior or through a duct or plenum and then to the exterior.

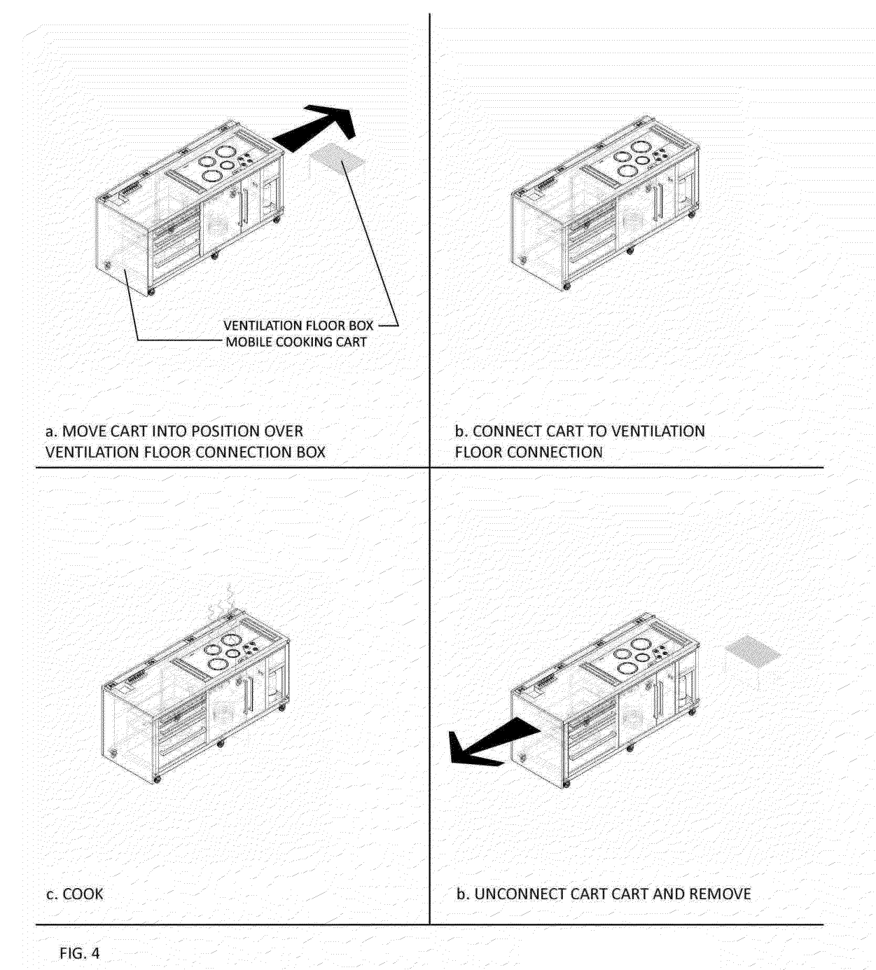

FIG. 4. shows the steps for moving the cart into an area with a connection, then connecting the cart for cooking and subsequently un-connecting the cart and removing it to clear the space for other uses once again. The mobile cart is moved into place over the floor connection. The floor box cover is removed and the floor duct connected to the duct onboard on the cart. The cart can now be used for cooking. After cooking the duct connection can be uncoupled, the floor box cover put back in place and the cart removed creating space for other activities.

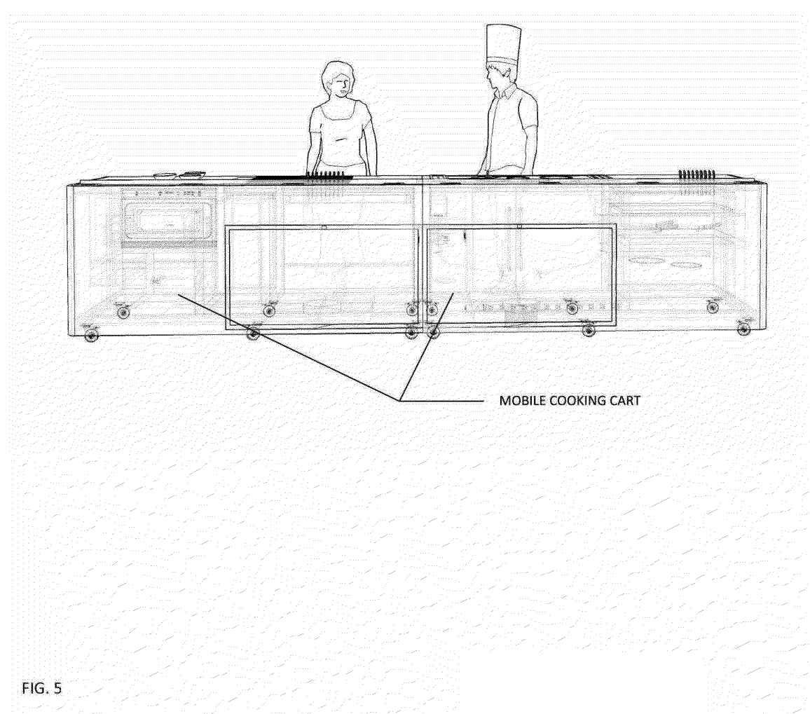

FIG. 5 showcases the view to the front of the invention from the audience view. These views are uninterrupted and are clear to the cart user, chef or cook.

The advantages of the present invention include, without limitation:

The present invention provides unobstructed views from the audience to the cart.

The present invention is mobile.

The present invention can be removed from the space with only a floor box cover remaining in the space instead of vent hoods or built-in cooktops.

The present invention can be moved to multiple locations in lieu of having to construct multiple kitchens in different spaces.

In broad embodiment, the present invention is a mobile cart that integrates cooktop and ventilation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A mobile cooking cart comprising:
A mobile cart; and a cooktop and ventilation system and additive means to attach said vehicle to a floor installed duct or plenum
